(19) United States
(12) Patent Application Publication
(10) Pub. No.: US 2004/0218038 A1
(43) Pub. Date: Nov. 4, 2004

(54) 3D image generation equipment and the method

(76) Inventor: Tommy Wai Ming Chan, Kowloon (HK)

Correspondence Address: RABIN & BERDO, P.C., Suite 500, 1101 14th Street, N.W., Washington, DC, 20005, US

(21) Appl. No.: 10/754,506

(22) Filed: Jan. 12, 2004

(30) Foreign Application Priority Data
May 2, 2003 (JP) 2003-127454

(51) Int. Cl. H04N 9/47; H04N 13/04; H04N 15/00

(52) U.S. Cl. 348/59

(57) ABSTRACT

Only 1 sheet from the photoed original picture is needed to perform the purpose of Lenticular-stereo printing.

One original picture image is photoed with a digital camera (18), and downloaded to personal computer (12). When software is performed with a personal computer (12), two or more various distance below the pitch of Lenticular Lens shifts an original picture image to a transverse direction. The virtual picture of two or more sheets is generated from the original picture image of one sheet. According to the print directions from personal computer (12), printer (16) prints the virtual picture of two or more sheets in the shape of a strip [of the direction of length] by turns for every distance which subdivides the above-mentioned pitch in the same plurality as the number of sheets of a virtual picture. By this, the printed picture turns into solid image observed as a solid through Lenticular Lens.

### FIELD OF INVENTION

This invention relates to the 3D image generation equipment and the method of using Lenticular Lens.

### BACKGROUND OF THE INVENTION

3D image generation technology is known as lenticular stereo printing. (Non-patenting reference 1, non-patenting reference 2). By this printing method, the picture of two sheets which photo the same object from a different viewpoint is compounded, and it arranges in the shape of a strip of paper by turns, and prints (Patent reference 1-Japanese Laid Open No.2003-111104). An observer observes printed matter through Lenticular Lens laminated after Lenticular-stereo printing. When observed through the Lenticular Lens, image in an observer's right eye is only one the picture (right eye picture). Also visible is the picture of another side in the left eye (the left eye picture) It is visible. Even if it makes artificially such azimuth difference produced in case man observes a solid and the object is printed by the plane, the principle of 3D image by Lenticular-stereo printing makes an observer feel an object three-dimensional. (Patent reference 2-Japanese Laid Open No. Heisei 9-127622).

“The Lenticular interlacing system made from Lenticular Image LLC [online)” is disclosed in the non-patenting reference 1 [April 25, Heisei 15 reference], Internet URL:http://WWW.i-fds.co.jp/Lenti-HP/set01.pdf.

The Ozaki complete recovery and Kazuhiro Negishi work “The newest common sense of printing” is disclosed in the non-patenting reference 2, the first edition, Nippon Jitsugyo Publishing Co., Ltd., Inc., September, 2001, p, 124-125.

### SUMMARY OF THE INVENTION

However, since 3D image obtained by Lenticular-stereo printing which uses man's azimuth difference, preparing the original picture image of two or more sheets is not avoided. That is, it is necessary to prepare two or more original picture images which photo the same object from two or more points to take a photograph. The method of generating and compounding the picture of a right eye and a left eye, in the method of patent reference 2, the original picture image of one sheet which photoes man's face is indicated. However, the standard solid structure of an object called man's face is expressed with this method needs to hold “standard structure information” beforehand. Therefore, if an object changes from man's face to other things it will means a new system become necessary. It is thought that introducing “standard structure information” into a system takes time.

The purpose of the invention is to solve the problems of such conventional technology, and aims at offering the 3D image generation equipment and the method of realizing 3D image by Lenticular-stereo printing simple from the original picture irrespective of the kind for photography.

Means for solving the problem: in order to solve the above-mentioned problem. This 3D image generation equipment which generates 3D image observed through Lenticular Lens arranged in the shape of a strip of paper. Every distance which subdivides the above-mentioned pitch for the generation means and the virtual picture of two or more sheets in the same plurality as the number of sheets of a virtual picture from the original picture image, one or more various distance below the pitch of wrench Lenticular Lens shifts the original picture image of one sheet to a transverse direction

By printing out the image, observers can inspect a 3D image through Lenticaular Lens.

According to this invention, 3D image by Lenticaular stereo printing is realized simply from the original picture image of one sheet irrespective of the kind for photography.

By use of this invention, real solid image (multi-depth picture)can be generated from the 2-dimensional original picture image. User can use one favorite photograph and not necessary to prepare two or more sheets of pictures for generating 3D image, it is very simple to use.

Moreover, if a user who have a personal computer and printer but do not have a digital camera, by buying a non-expensive 300,000-pixel digital camera with software. Further more, a mobile equipped with a digital camera etc. may also be used. A user can enjoy 3D image by purchasing only software in that case.

The software of this invention which performs the solid 3D image generation progress carries out the functions all by itself. Moreover, time to generate solid 3D image is short and a 5 inch×7 inch photograph can be made into solid 3D image in 10 seconds. Also, the size of the picture generated is also changeable. Furthermore, it is the system which generate precise virtual 3D image.

With reference to an appended drawing, the case of the operation of the 3D image generation equipment by this invention and a method is explained in detail. In addition, in each drawing, the element without the direct relation to this invention is omitted. Moreover, with the same element, the same reference number will be used.

### BRIEF DESCRIPTION OF DRAWINGS

FIG. 1 is the block diagram showing the operation of the solid 3D image generation equipment.

FIG. 2 is the detailed block diagram of the personal computer 10 of FIG. 1.

FIG. 3 is the figure of the execution screen of the software which performs the solid 3D image generation progress.

FIG. 4 is the figure which shows one picture on the main screen of FIG. 3 with the background eliminated.

FIG. 5 shows the execution screen displaying the synthetic picture of two pictures chosen from FIG. 4.

FIG. 6 shows Lenticular-principle of 3D image generation

FIG. 7 shows virtually solid 3D image generated by the solid 3D image generation method of this invention.

FIG. 8 is same one having photoed the object from two or more imagination viewpoints shown in FIG. 7, two or more pictures was printed, and laminated with Lenticular Lens.

FIG. 9 is the figure showing the process which generates a multi-depth picture from the picture which photoes the object shown in FIG. 8 by the solid image generation method of this invention.

FIG. 10 is a figure showing changing function or motion function, it is the figure of the software execution screen at the time of the motion mode which generates a picture.

FIG. 11 is the Lenticular-principle figure which performs changing function.

FIG. 12 is the figure showing an example of the picture shown in FIG. 11.

FIG. 13 is the general-view of photo stand which performs changing and motion function.

### DETAILED DESCRIPTION OF PREFERRED EMBODIMENT

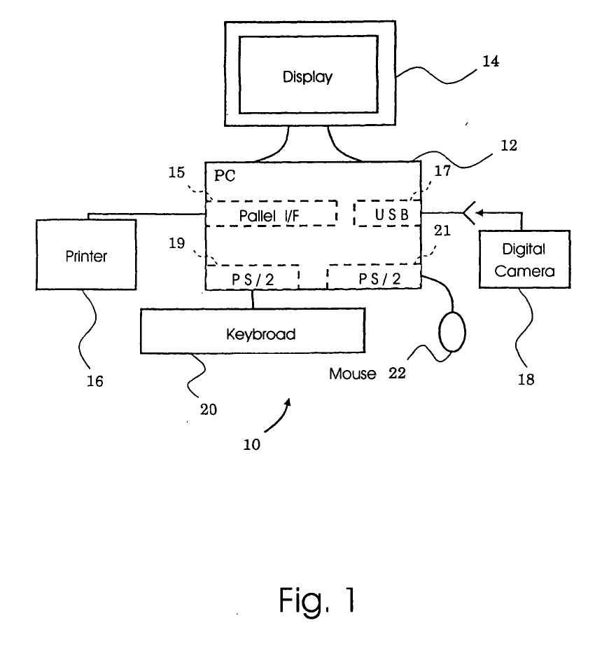

FIG. 1 is a block diagram showing the case of the operation of the 3D image generation equipment by this invention. The 3D image picture generation equipment 10 is wrench Lenticular Lens arranged in the shape of a strip. It is equipment which generates 3D image by observing through the Lenticular Lens. To the merit shown in FIG. 1, the 3D image generation equipment 10 is a personal computer 12 and two or more apparatus connected to the personal computer 12 with each interface being included. These apparatus contains a display 14, a printer 16 which is connected to the personal computer 12 through the parallel interface 15, a digital camera 18 which is attachable and detachable to the personal computer 12 through USB 17 (Universal Serial Bus), and a keyboard 20 and mouse 22 which are connected to the personal computer 12 through the PS/2 interfaces 19 and 21.

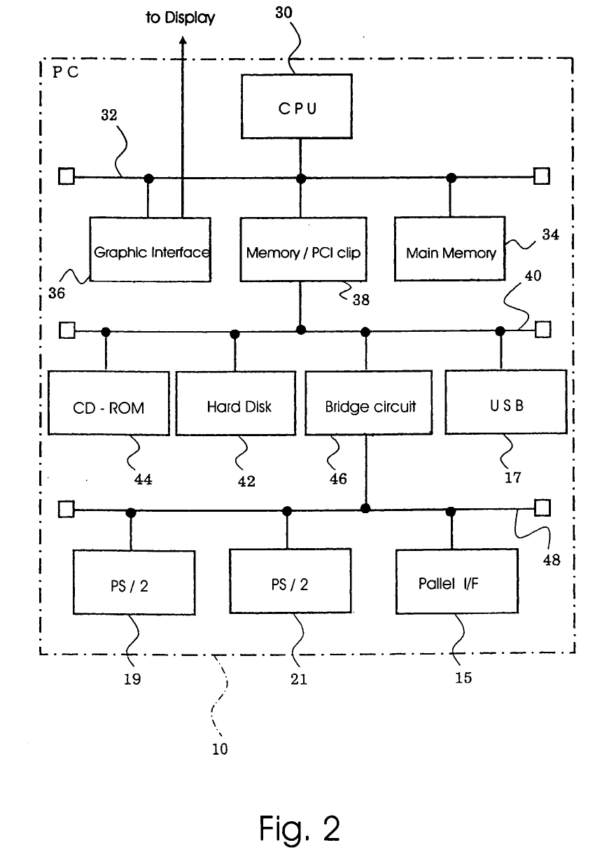

The personal computer 12 will be explained in FIG. 2 in full detail. The equipment generates 3D image using the digital image downloaded from a digital camera 18. A display 14 is equipment which displays the execution screen of the software which realizes the 3D image generation method by this invention. In the execution screen concerned, the display 14 can display the original picture image of one or more sheets photo with the digital camera 18. A printer 16 is equipment which prints the picture generated and compounded by software.

A digital camera 18 is the equipment which photos the digital original picture image and the latter is downloaded through personal computer 12 into hard disk 42. You may decide the number of pixels the number of pixels of a camera 18 fluctuate freely and there should just be about 300,000 pixels. Moreover, a digital image may also obtained by any equipment that can take a digital photo, and you may also connect portable telephone and others which has a photo function to a personal computer 12.

FIG. 2 is a detailed block diagram of the personal computer 12 shown in FIG. 1. CPU (Central Processing Unit) 30 is equipment which carries out a program based on the command which performs the main memory 34 and data which are accessed through the processor bus 32, and is sent from a main memory 34. It is made to display on a display 14 through the graphics display mechanism 36 in which a real execution result performs a display into the display 14 for a program. In addition, although a certain capacity of 32 M bytes or more of a main memory is desirable, you may make it fluctuate freely.

A memory/PCI control tip 38 is interfaces which mediate the processor bus 32 and PCI bus 40 which is a low speed communication device. In addition to USB17 which is the interface of a digital camera 18, the hard disk 42 and the CD-ROM (Compact Disc-Read Only Memory) drive 44 are connected to PCI bus 40. Although it is desirable that it is 60 M bytes or more as for the storage capacity of a hard disk 42, you may make it fluctuate freely. Although not illustrated, the software which realizes the 3D image generation method by this invention is installed in the hard disk 42 which is memory storage. Or this software may not be installed in a hard disk 42, but may be read into the direct processor bus 32 from the compact disk 44 which recorded software, and may be performed by CPU30. Furthermore, this software installs a part in a hard disk 42, may read only an auxiliary function from a compact disk 44, and may perform it. Anyway, this software which is read from equipments 42 or 44, is temporarily stored in a main memory 34, and is performed as a program by CPU30. Moreover, the hard disk 42 is also a record means to download and record the original picture image of one or more sheets photo with the digital camera 18 through USB17.

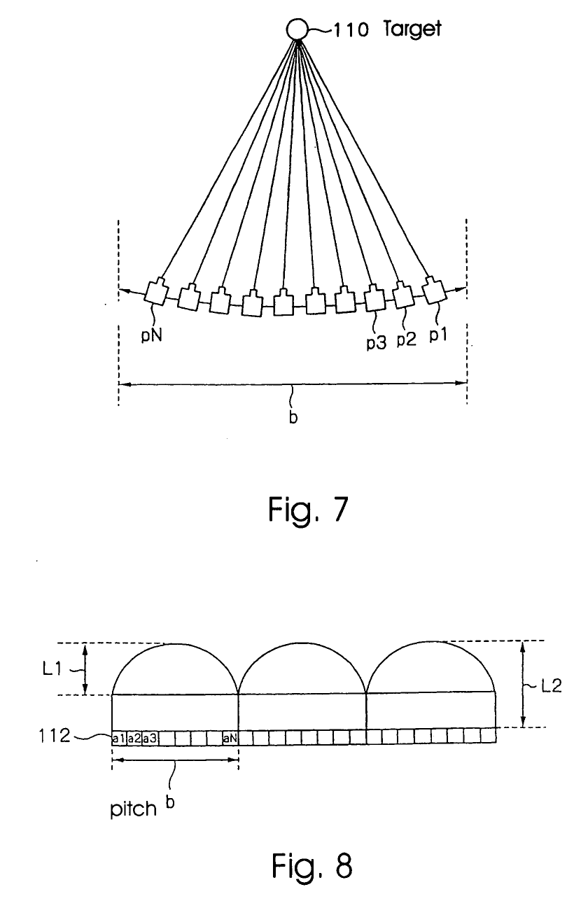

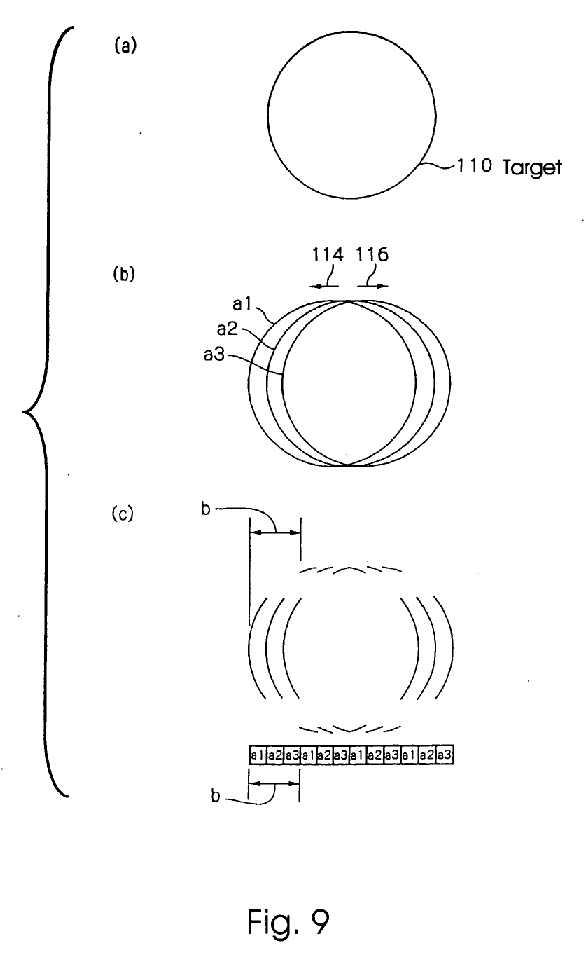

By performing the above-mentioned software, CPU30 functions as a picture generation means to generate the virtual picture of two or more sheets from the original picture image of one sheet, when two or more various distance below the pitch of Lenticular Lens shifts the original picture image of one sheet to a transverse direction. This will be described in details later with reference to FIG. 7 and FIG. 9.

The bridge circuit 46 is an interface which mediates PCI bus 40 and ISA Bus 48 which is a low speed communication device. The PS/2 interfaces 19 and 21 which are interfaces of the keyboard 20 and mouse 22 which are already described input apparatus, and the parallel interface 15 which is an interface of the printer 16 is connected to ISA Bus 48. A keyboard 20 and the incoming signal from a mouse 22 are sent to the processor bus 32 through the ISA bus 48 and PCI bus 40 through interfaces 19 and 21, and are inputted into CPU30. Moreover, the print command from CPU30 follows a course contrary to this, and is sent to a parallel interface 15, and a printer 16 prints according to a print command. Printer16 is good as an ink-jet printer and all kinds of LASER beam printer and other printer can be used.

A printer 16 functions according to the directions from CPU30, i.e., a print command, as a print means to print the virtual picture of two or more sheets in the shape [of the direction of length], a strip of paper by turns for every distance which subdivided the pitch of Lenticular Lens in plurality. This print method will be described later with reference to FIG. 7 or 9 in detail.

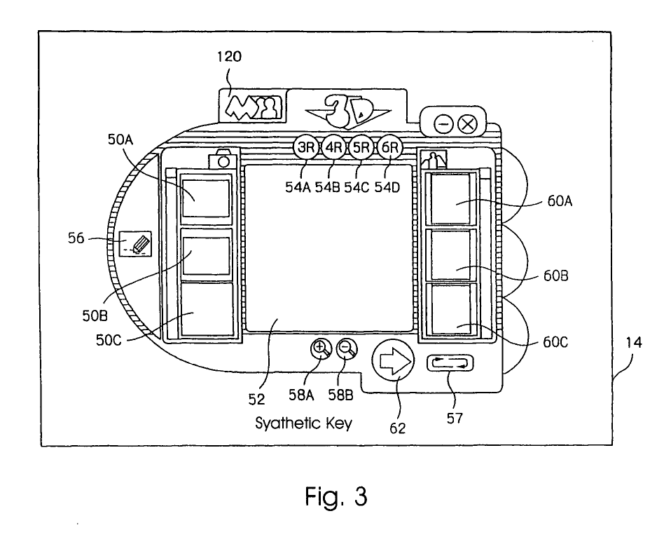

FIG. 3 is the execution screen of the software which realizes the 3D image generation method by this invention, and is displayed on the display 14 of FIG. 1. The function of this software is divided roughly into following five points, and is performed by the respectively separate program.

It is the multi-depth picture generation system which generates a solid picture from the mere 2-dimensional original picture image downloaded in the personal computer. The size and the solid value of a 2-dimensional picture can be changed freely. Multi Depth image is a picture which can view like solid object, in order to enable observation of an object as a 3-dimensional solid. (DEPTH) They are two or more sheets information (multi image). Second, 3D image freely generable from any photographs is saved in a personal computer. Thirdly, it considers as the motion picture which generates two or more separate photographs, and is horizontally flipped to it. To the 4th, it considers as the motion picture which generates two or more separate photographs, and is perpendicularly flipped to it. 5th, 3D image or the flip effect is generated in one picture from the picture downloaded in the personal computer.

There are two modes in this software. One is 3D (3-Dimension) mode shown in FIG. 3, and it is the mode which generates 3D image. Although another mentions later, a picture changes with the directions to see “changing”, or it is the motion mode which generates the picture which has “a flip” and many functions called a “motion.” In any mode, operation of software is performed by clicking the various buttons fundamentally displayed on the execution screen of software with the pointing device of mouse 22 and others, or a keyboard 20 may perform. These mice 22 and keyboard 20 also play a role of a selection means to choose arbitrary pictures from the original picture image of one or more sheets displayed on the display 14 with the execution screen of software.

In 3D mode of FIG. 3, the left-hand side screens 50A-50C display the photograph which a photograph was taken with the digital camera 18, and was downloaded to the hard disk 42. The central main screen 52 displays one photograph chosen from either of the screens 50A-50C. Four buttons 54A-54D displayed as 3R/4R/5R/6R are buttons which determine the size of a photograph. For example, 3R of 3 inch×5.5 inch and 4R of 4 inch×6 inch, 5R 5 inch×7 inch and 6R is 6 inch×8 inch are desirable.

If the edit button 56 is pushed, the picture displayed on the main screen 52 can be edited. It is eliminating the unnecessary background of a photograph or adjusting in the size which suits the main screen 52 using “edit function”. In addition, if a reset button 57 is pushed, background elimination work can be stopped on the way, and the background can be returned.

The zoom buttons 58A and 58B is buttons which change the display size of a photograph. In case this performs the above-mentioned edition, it changes the display method of a photograph and zoom in and zoom out are possible for it so that it may be easy to do work.

The right-hand side screens 60A-60C are screens which store the edited photograph. If the photograph edited on the main screen 52 is picked and carried out, a photograph is storable in either of the screens 60A-60C.

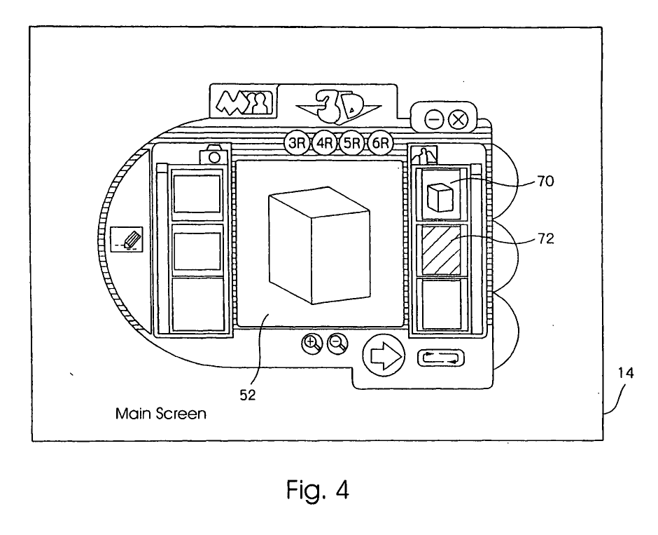

The synthetic key 62 is a button which generates 3D image from the picture which was edited and was stored in screens 60A-60C. In order to compound a photograph, what is necessary is to pick two completed photographs to the main screen 52 separately, by a push on the synthetic key 62 from screens 60A-60C. FIG. 4 is a figure which chose one picture 70 which eliminates the background first, and was displayed on the main screen 52. And what is necessary is to choose another picture 72, just to push the synthetic key 62. In addition, CPU30 to which a picture composition means to compound other selected original picture images 72 performs software bears this in this way as a background of the original picture image 70 of one sheet formed into 3D image.

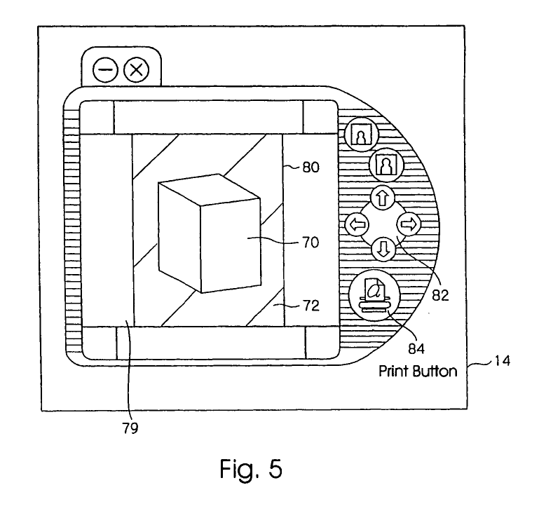

FIG. 5 is the execution screen of the software which displays the synthetic picture of two pictures which were chosen as mentioned above and compounded. When it compounds, the software also changes and it is specified that it is a synthetic picture. The picture of the rectangular parallelepiped 70 which eliminates the background is displayed on the merit shown in the main screen 79 of FIG. 5 by the front, and the background picture 72 of another side is compounded as a background. In addition, the move button 82 is a button which can move vertically and horizontally about the synthetic picture 80.

The print button 84 is a button for printing the synthetic picture 80 by the printer 16. On display 14, in this way, although the synthetic picture 80 is not visible to two dimensions, when printing is performed by printer 16, this software can make 3D image the picture 70 of the rectangular parallelepiped displayed on the front when printing out. That is, the feature of the 3D image generation method by this invention is generating 3D image from the picture 70 of one sheet. The mechanism is explained as follows:

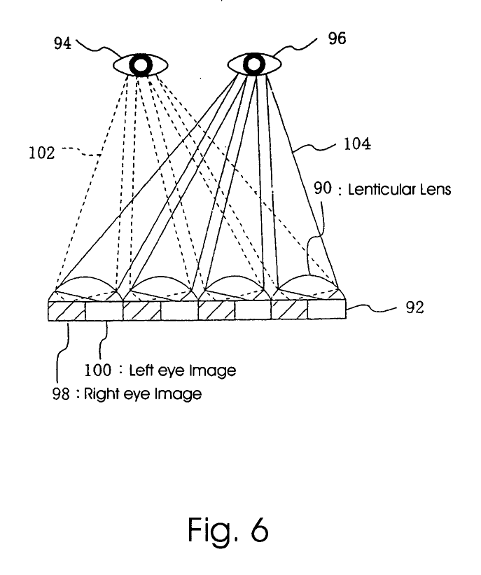

To explain the principle of 3D image as a premise here, FIG. 6 shows the lenticular principle which realizes 3D image. Lenticular Lens 90 which is a boiled-fish-paste type convex lens below thickness 1 mm made from a plastic, is cast together with the shape of a strip, and is stuck on printed matter 92. If printed matter 92 prints still more finely the right eye picture 98 and the main left picture 100 in the shape of a strip and does not view them through Lenticular Lens 90, what is printed does not appear clearly. As a dotted line 102 shown in the figure, the right eye picture 98 is projected only on a right eye 94, and the left eye picture 100 is projected only on the left eye 96. Thus, by projecting a respectively separate picture on man's right eye 94 and 96 in left eye, man feels an object three-dimensional.

FIG. 7 is a figure showing virtually 3D image generated by the 3D image generation method by this invention. The feature of this software shows a picture in three dimensions substantially by generating N pictures same with having photo the object 110 from various viewpoints just like using the cameras p1, p2, p3-pN virtually shown in FIG. 7 [it is generating a multi-depth picture from the picture of one sheet].

FIG. 8 is a figure which printed virtual picture al-aN same with having photo by imagination viewpoint pl-pN shown in FIG. 7, and laminated with Lenticular Lens. If virtual picture al-aN is printed by this software by arrangement suitable on printed matter 112 and Lenticular Lens is laminated like illustration in the printed picture, a view with depth will be acquired.

N which is the number of sheets of a multi-DEPUSU picture is calculable from the pitch data b of Lenticular, and the resolution of a printer 16. For example, pitch data presupposes that it is given by length called 60LPI(s) (Lines per Inch), i.e., b=1/60 inch. On the other hand, suppose that the resolution of a printer 16 is 600 DPI (Dots Per Inch). In this case, the number of sheets N of a multi-DEPUSU picture - - - N2 - - - 600/60 - - - 2 - - - it is calculable with 10 (sheet).

FIG. 9 is a figure showing the concrete process which generates the multi-depth picture 112 shown in FIG. 8 from the picture which photos the object shown in FIG. 7 by the 3D image generation method by this invention. As an original picture image is shown in FIG. 9(a), suppose that an object 110 is a ball. And it is a picture, as it is shown in the arrows 114 and 116 of FIG. 9(b), when it is the number N=3 of a multi-depth picture. An original picture image is shifted by the number N and the original picture image of one sheet shifts two or more various distance below the pitch b of Lenticular Lens to a transverse direction. In this case, since it is N=3, as shown in FIG. 9(b), virtual pictures al˜a3 of the ball of three sheets mutually shifted are generated from the original picture image of one sheet. And FIG. 9(c) shows the printed picture. Virtual pictures al˜a3 are printed in the shape of a strip by turns for every distance which subdivides the pitch b of Lenticular Lens in three pieces - - - each ball picture al, a2, or a3 is printed in order in the shape of a strip, and the print of the shape of this strip of paper is repeated consequently, the printed picture turns into a multi-depth picture to which the outline faded to multiplex.

When the multi-depth picture printed by doing in this way is seen through a Lenticular Lens, man's right eye and left eye will look at each drawing as follows, respectively. It is assumed that N=6, if the right eye picture which is visible to a right eye in a certain position is a1, the left eye picture which is visible to attention will be set to a4. And when man's head carries out displacement horizontally, a right eye picture changes from a1 to a2 to a3 to a4 as a multi-depth picture is observed from an angle which changes the viewpoint of the object. In this case, a left self-portrait changes with a4 to a5 to a6 to a1 simultaneously. That is, a right eye picture and a left self-portrait set a fixed interval, and change, and, in the case of an above-mentioned example, there is an interval for three layers of pictures. This interval is determined by the form of the Lenticular lens which becomes settled with the length L, L2, and b shown in FIG. 8. Thus, when a right eye and a left eye perceive the picture shifted simultaneously, man feels an object three-dimensional. That is, the printed picture turns into 3D image observed as a solid through Lenticular Lens.

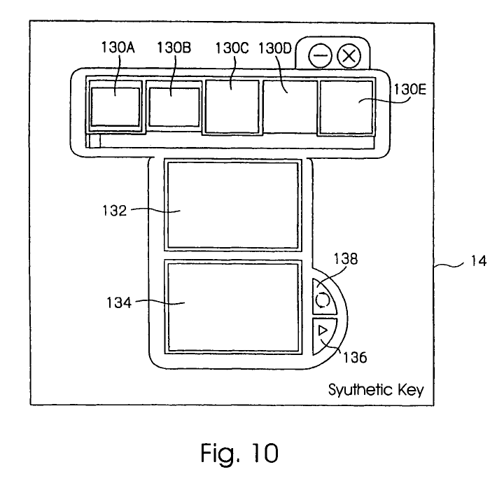

In FIG. 10, the software which realizes the 3D image generation method by a picture changes with the directions which look at “Changing” or “Flip” and it is the execution screen in which the motion mode which generates the picture which has many functions called “Motion” is shown. When the motion mode change button 120 of the execution screen shown in FIG. 3 is pushed, and motion mode will perform in display 14. Two original picture images can be chosen from the upper screens 130A-130E, and the draw of them can be carried out to every one of lower screens 132 and 134. And synthetic key 136 can be pushed and a picture can be compounded. In addition, if a reset button 138 is pushed, the picture displayed on screens 132 and 134 is eliminated, redo selection is also available.

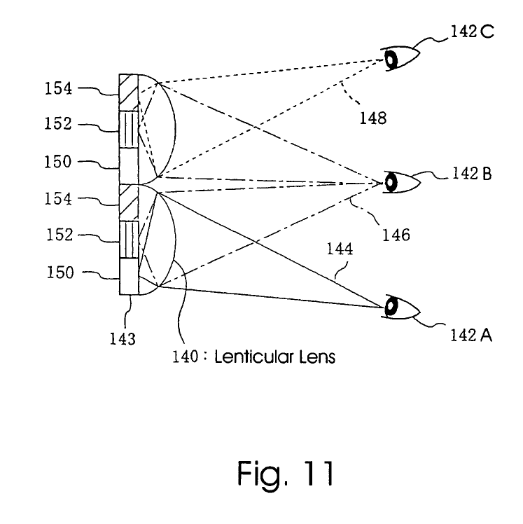

FIG. 11 shows the Lenticular-principle perform changing and motion. That is, it is the figure showing the synthetic picture obtained in the motion mode shown in FIG. 10 is printed. If only a different point from FIG. 6 is explained, the direction of Lenticular Lens 140 arranged in the shape of a strip and the direction where the eye of right and left of man is located in a line are substantially parallel. In other words, in FIG. 6, although man's eyes are looking at Lenticular Lens arranged in the shape of a Vertical strip, and Lenticular Lens arranged in the shape of horizontal strip of paper is seen in FIG. 11. Therefore, although the same picture will be seen simultaneously at 142A and 142C, the pictures which are visible with different position will be different. Three kinds of pictures 150, 152, and 154 are printed by printed matter 143 in the shape of a strip. When human eyes move to position 142A and position 142B position 142C. Picture 150, 152, 154 which is different in the merit shown by the solid line 144, point line 146, and the dotted line 148, respectively, the pictures 152, and 154 are projected to right and left eye respectively.

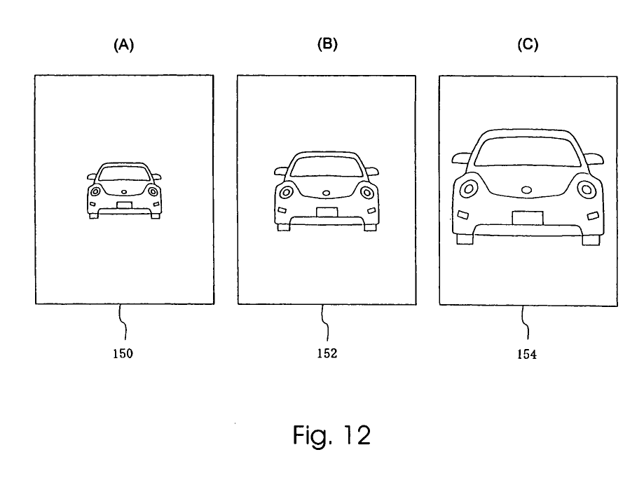

FIG. 12 is the example of pictures 150, 152, and 154 shown in FIG. 11. Since a visible picture changes in order of pictures 150, 152, and 154 as human viewpoint moves to position 142B from position 142A, and also position 142C as mentioned above, as shown in FIG. 12 (A) or (C), the motion which a car approaches gradually is realized. In FIGS. 11 and 12, on the facilities of illustration, although the picture of three sheets is included in one printed matter, a 50 picture can be included in one printed matter that can realize a more precise motion.

The operation of the 3D image generation equipment by this invention constituted as mentioned above will be explained here. As shown in FIG. 1, a user takes photo of the object using a digital camera 18, and connects the camera 18 to personal computer 12 by the USB cable. And the picture photoed using the predetermined software for digital cameras 18 is downloaded to the personal computer. It loads and stores in the hard disk 42 shown in FIG. 2. The downloaded picture may be edited with edit software, for example, may be changed into the size of 640×480 pixels.

The procedure of printing a multi-depth picture and realizing 3D image is as follows. That is, the software which carries out the 3D image generation method by this invention is started, and it considers as the 3-D mode shown in FIG. 3. The original picture image can be freely chosen from Screens 50A-50C using a mouse 22 or keyboards 20 then change it to 3D image. The selected picture is carried out to the main screen 52, and edits using the edit button 56. A picture to form into a multi-depth picture can be edited, for example, eliminating a background etc. The picture which completed edition is carried out to main screen 60A-60C, and it is stored in it. And two pictures are chosen from these screens 60A-60C and draw to main screen 52, then synthetic key 2 is pushed and pictures are compounded together. The synthetic picture 80 shown in FIG. 5 is printed on paper or any other print media by the printer 16 based on the principle shown in FIG. 7 and 9. Thereby, a multi-depth picture is obtained.

On the Multi-depth picture printed in the shape of [of the direction of length] a strip as shown in FIG. 9(c), When Lenticular Lens that has a suitable lens pitch is laminated as shown in FIG. 8, The target object will look solid with depth view, and 3D image will be realized.

On the other hand, the method of printing the picture which performed change or a motion is as follows. That is, when the software which performs the solid image generation method by this invention is started, it will maintain at motion mode as shown in FIG. 10. Two pictures are chosen from Screens 130A-130E, and draw into lower screens 132 and 134. And a synthetic picture is completed by pushing the synthetic key 136.

As shown in FIG. 11, if the picture printed in the shape of a horizontal strip laminates with a Lenticular Lens on its top, the picture will change its view when human eyes move in the vertical direction. When a completely different picture is compounded, it call ” change”, and we call it “motion” when the picture compounded changes gradually, as shown in FIG. 12.

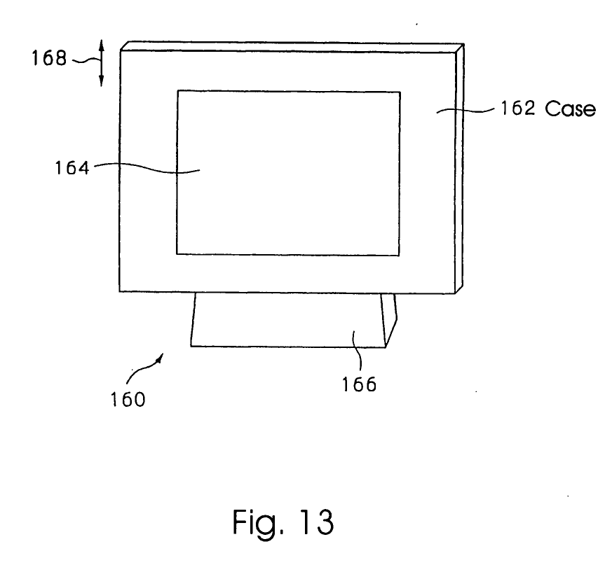

As for the synthetic picture printed in the shape of horizontal strip which perform change or a motion effect, it is good to contain and appreciate to photo on stand shown in FIG. 13. The transparent sheet 164 of the case162 on the photo stand 160 is a Lenticular Lens with horizontal strip. Moreover, in the case part 162, as the battery-type motor is installed although not illustrated at the photo stand bottom 166, and arrow 168 shows, both-way movement is gently [up and down] possible. As shown in FIG. 11, man does not need to change the height of his eye to view the photograph, and by use of this photo stand, man can stands it still and enjoy the 3D photograph. Because the photograph stored in the case part 162 moves, photograph will looks automatic changes or a motion is realized.

Explanation of reference number in drawings

10 Solid image generation equipment

12 Personal computer

14 Display

16 Printer

18 Digital camera

30 CPU

80 Synthetic picture

What is claimed is

1. A 3D image generation equipment, wherein the equipment can obtain 3D image when object is arranged under a strip shaped Lenticular Lens in longitudinal direction, the 3D image generation equipment generates 3D image by viewing the object under this equipment when one or more various distance below the pitch of above-mentioned Lenticular Lens shifts to a transverse direction, the original picture image of one sheet generates multiple virtual images, and a picture from the original image,
the equipment comprising a print means which subdivides the above-mentioned pitch for the virtual picture of two or more sheets in the plurality to print in the shape of a strip of paper by turns for every distance;
the print will obtain 3D image when observed under a strip shaped Lenticular Lens, this 3D image generation equipment characterized by becoming 3D image observed as a solid through above mentioned Lenticular Lens.

2. The equipment according to claim 1, wherein it also includes a record method to record the original picture image of one or more sheets, a display which can display the original picture image of one or more sheets and a selection means to choose arbitrary pictures from the original picture image of one or more sheets;
this 3D image generation equipment characterized by the ability to choose freely the original picture image of the one above-mentioned sheet formed into 3D image.

3. The equipment according to claim 2, wherein the 3D image generation equipment characterized by including a photography means for this equipment to photo the original picture image more than the above-mentioned number, and to provide a record method to record the original picture.

4. The equipment according to claim 3, wherein the 3D image generation equipment characterized by the above-mentioned photography means being a digital camera in equipment.

5. The equipment according to claim 2, wherein the 3D image generation equipment characterized by including a picture composition means to compound other original picture images chosen from the original picture image with more than the above-mentioned number as a background of the original picture image.

6. The equipment according to claim 4, wherein the 3D image generation equipment characterized by including a picture composition means to compound other original picture images chosen from the original picture image with more than the above-mentioned number as a background of the original picture image.

7. A 3D image generation method, wherein the method comprising the steps of generating 3D image observed through Lenticular Lens arranged in the shape of a strip, and when only one or more various distance below the pitch of above-mentioned Lenticular Lens shifts to a transverse direction, the original picture image of one sheet generates multiple virtual images, this process which generates the picture of two or more sheets from the original picture image of one sheet, subdivides the above-mentioned pitch for the picture of two or more sheets in this plurality and which is printed in the shape of a strip of paper by turns for every distance;
by this, this 3D image generation method characterized by becoming 3D image observed as a solid through above-mentioned Lenticular Lens.
